(19) United States
(12) Patent Application Publication
(10) Pub. No.: US 2002/0163649 A1
(43) Pub. Date: Nov. 7, 2002

(54) Film thickness measuring method and apparatus, and thin film device manufacturing method and manufacturing apparatus using same

(75) Inventors: Takenori Hirose, Machida (JP); Mineo Nomoto, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/081,385

(22) Filed: Feb. 20, 2002

(30) Foreign Application Priority Data
Mar. 19, 2001 (JP) 2001-078878

(51) Int. Cl. G01B 11/02

(52) U.S. Cl. 356/504

(57) ABSTRACT

In order to be able to automatically define significant measurement points for measuring the film thickness of a transparent film on a circuit pattern buried under an optically transparent thin film, in a method for determining measurement points for measuring film thickness, whereby measurement points for measuring the film thickness of optically transparent thin film on a circuit pattern formed on a wafer beneath an optically transparent thin film, are determined automatically, light is irradiated onto the surface of the wafer, either intermittently or continuously, starting at a predetermined provisional reference measurement point in the region of a particular chip on the wafer, and following a predetermined path of travel in the vicinity of this provisional reference measurement point, the light reflected by the wafer is detected, and the measurement points for measuring film thickness are determined on the basis of spectral waveform data for the reflected light thus detected.

### BACKGROUND OF THE INVENTION

The present invention relates to a method for measuring the thickness of optically transparent thin film, and more particularly, to a technique wherein measurement points are automatically determined for measuring the thickness of an optically transparent thin film on a circuit pattern which is formed on a wafer and buried under an optically transparent thin film. More particularly, the invention relates to a technique used in a manufacturing line manufacturing semiconductor devices onto silicon wafers, or the like, whereby significant measurement points are determined based upon the premise that they are for measuring the thickness of an optically transparent thin film which has undergone leveling after the film deposition stage. In addition to the foregoing, optically transparent thin films include resist films and insulating films, and the like, employed in manufacturing stages of thin film devices, such as DVD, TFT, LSI reticles, and the like.

Let us consider, for example, a CMP (Chemical Mechanical Polishing) process in a manufacturing line for semiconductor devices. A semiconductor device is manufactured by forming devices or wiring patterns onto a silicon wafer, by processes such as film deposition, exposure, etching, and the like. In recent years, in order to achieve higher precision and higher density in such devices, there have been moves towards greater fineness and increased layering, which have resulted in an increase in the number of indentations in the wafer surface. Such indentations in the wafer impede the light exposure process, which is essential in forming wiring, and the like, and therefore levelling of the wafer surface is carried out. The aformentioned CMP process is used for this levelling process, wherein the surface of the wafer is levelled by polishing based on chemical and physical actions. CMP is a commonly known technique in the related technological field.

However, there are many cases in, for example, a wiring stage in the manufacturing process for a semiconductor device, where the surface is not completely levelled, even after CMP processing. The reason for this is non-uniformity of the local occupancy ratio of the circuit pattern (pattern surface ratio) located in the lower layer of the transparent film. It is generally known that there is a correlation between the surface area ratio of the circuit pattern located in lower layer of the transparent film and the thickness of the optically transparent thin film after processing. A large variation in the film thickness after processing this will cause problems in the subsequent exposure and etching stages, and hence the film thickness must be controlled after CMP processing.

Controlling film thickness in CMP is considerably problematic. In the prior art, this has generally been achieved by means of processing time. In other words, a polishing rate is calculated from the polishing amount as derived by measuring the film thickness before and after CMP processing, and the polishing time for which CMP was actually performed, and this calculated polishing rate is supplied as feed-back into the next processing time. Furthermore, a method may also be employed whereby the film thickness is controlled by measuring at predetermined measurement points, in order to confirm that the film thickness after processing comes within a prescribed film thickness range, this film thickness measurement being performed on a pattern formed in the peripheral region of the chip, or the like, (dummy pattern) having sufficient size to be measured satisfactorily by a conventional measuring device. However, in this film thickness controlling method, the film thickness is not measured in the required position in the middle of the actual device pattern (the actual fine circuit pattern of the product).

Japanese Patent Laid-open No. (Hei)6-252113 and Japanese Patent Laid-open No. (Hei)9-7985 disclose in-situ measuring systems capable of measuring the film thickness at the device pattern. Furthermore, Japanese Patent Laid-open No. (Hei)9-109023 discloses an in-line measuring system for achieving increased through-put by measuring film thickness after processing whilst the device is held in water and before it has been cleaned. In Japanese Patent Laid-open No. (Hei)6-252113 described above, the spectrum of the interference pattern produced by the film from white light is analyzed with respect to frequency, and the absolute value of the thin film is calculated by observing the relationship between the frequency component relating to the spectral waveform and the film thickness. Moreover, in Japanese Patent Laid-open No. (Hei)9-7985 described above, the change with respect to processing time of the intensity of the interference pattern produced by the film from a laser (single-wavelength source) is detected and the film thickness is calculated from the frequency component relating to that waveform.

Moreover, Japanese Patent Laid-open No. (Hei)9-193995 discloses an in-situ measuring system for detecting a processing end point by detecting the extreme position (wavelength) of the spectral waveform.

Furthermore, Japanese Patent Laid-open No. 2000-241126 discloses a method for calculating a thin film thickness by fitting a detected spectral waveform and a theoretical waveform derived from a model.

Furthermore, Japanese Patent Laid-open No. 2000-9437 proposed previously by the present applicants discloses a technique whereby the film thickness of a transparent thin film on a circuit pattern buried by an optically transparent thin film can be measured, provided that the pattern area ratio within the measurement field of view of the film thickness measuring device (pattern area of circuit pattern occupying the measurement field of view) is equal to or greater than a certain value. In the technique described in Japanese Patent Laid-open No. 2000-9437, it is possible to achieve precise measurement of the thickness of a transparent thin film on the actual circuit pattern of the product, and by evaluating the thickness distribution within the chip, it is possible to perform accurate evaluation of the film thickness, without requiring expertise.

However, the respective patents disclosed above do not disclose a technique for automatically setting measurement points for film thickness measurement to significant points. Desirably, the measurement points for measuring film thickness should satisfy the following conditions: (1) enable film thickness evaluation within wafer surface and within whole chip (for example, evaluation of maximum film thickness and minimum film thickness), and (2) number of measurement points should be few (to maintain throughput), but in order to determine measurement points satisfying these conditions, the operator is required to have expertise, and a long period of time is necessary for the actual point determining operation.

Moreover, Japanese Patent Laid-open No. (Hei)8-304023 discloses a technique whereby, in order to confirm the position at which measurement is actually made when measuring film thickness, measurement point candidate co-ordinates on the wafer under observation are calculated from relative positional data for the wafer and representative measurement point co-ordinate values, as derived from design information, by moving the XY table in such a manner that representative measurement points in a captured image coincide with predetermined target measurement points. Moreover, Japanese Patent Laid-open No. (Hei)6-331320 discloses a technique whereby, in order to confirm the position at which measurement is actually made when measuring film thickness, the optical reflectivity in a prescribed region is studied, and the film thickness is measured at a position of highest reflectivity, this being a region where the portion below the transparent film on the face irradiated by the light beam is formed entirely by an electrode.

The techniques disclosed in Japanese Patent Laid-open No. (Hei)8-304023 and Japanese Patent Laid-open No. (Hei)6-331320 are aimed principally at accurately locating the position of the XY table on which the wafer is mounted, with respect to the film thickness measuring device, rather than automatically determining the required measurement points located in the actual body of the chip product. In other words, in measuring film thickness after CMP processing, it is essential to measure the thickness of the transparent film on the circuit pattern buried below an optically transparent thin film, and if the technique disclosed in Japanese Patent Laid-open No. 2000-9437 described above is used to perform this film thickness measurement, then it is necessary to specify locations on the transparent thin film here the circuit pattern exceeds a prescribed pattern area ratio. However, the operator's task of determining a plurality of measurement points on the chip, by visually observing a microscope field of view or a screen displaying a captured image, is laborious and time-consuming, and the measurement points thus determined are not based on objective judgement criteria.

Considering, for example, a wiring process in a semiconductor device manufacturing process, a completely flat surface often does not result, even when CMP processing is applied. The reason for this is that the ratio of the local plane of the layer beneath the film that is occupied by the wiring pattern (the pattern area ratio) is not uniform. It is generally known that there is a correlation between the surface area ratio of the pattern located in the lower layer and the thickness of the film after processing.

If there is a large variation in the film thickness after processing, this will cause defects in the subsequent exposure and etching steps, and hence the film thickness must be controlled after processing.

Japanese Patent Application Laid-open No. 2000-9437 discloses a technique which permits submicron-order measurement of the film thickness on a device pattern, in order to evaluate the variation in the film thickness. The film thickness is determined by frequency analysis of detected spectral data. However, in this method, if the film thickness to be measured is small compared to the detection wavelength band, then it becomes difficult to measure the film thickness. Nevertheless, Japanese Patent Laid-open No. 2000-241126 discloses a method for measuring film thickness by fitting, which is applicable to films of relatively small film thickness also. However, in the technology thus disclosed, in cases where the thickness of a thin film formed on a finely detailed pattern is being measured, the measurement accuracy is affected greatly by the pattern density, and hence the method cannot be used for high-precision measurement with respect to a variety of patterns.

Therefore, it is an object of the present invention to provide a film thickness measuring method and apparatus based on fitting, whereby film thickness can be measured even with respect to finely detailed patterns, and a thin film device manufacturing method and manufacturing apparatus using same.

Moreover, Japanese Patent Application Laid-open No. 2000-9437 discloses a method wherein accurate evaluation of film thickness can be achieved without great proficiency, by evaluating the film thickness distribution within a chip.

However, in order to evaluate the film thickness distribution in the chip, for example, to measure 10×10=100 points, it has been necessary for the operator to set the positions of the 100 measurement points.

Therefore, it is a further object of the present invention to provide a method and apparatus for automatically determining measurement points, and to provide a method and apparatus for manufacturing a thin film device using same.

### SUMMARY OF THE INVENTION

The present invention was devised with the foregoing in view, and in the method according to the present invention, firstly, measurement points are determined for performing film thickness measurement in order to measure the thickness of an optically transparent film formed so as to cover a circuit pattern formed on a substrate, the film thickness is then determined by successively measuring at the measurement points thus determined, and the distribution of the film thickness on the substrate, or on chips formed severally on the substrate is derived.

In other words, in the present invention, light is irradiated onto a particular chip of a plurality of chips on a wafer formed with a plurality of chips whereon a circuit pattern and an optically transparent thin film for covering said circuit pattern are formed respectively; the light reflected by the particular chip region of said wafer due to said irradiated light is detected; measurement points for measuring the film thickness of said optically transparent thin film on said wafer are determined by using information for the spectral waveform data of the reflected light thus detected; and the film thickness of said optically transparent thin film at said measurement points is measured, by successively irradiating light onto the measurement points thus determined.

Furthermore, in the present invention, light is irradiated onto a portion of a wafer whereon a circuit pattern and an optically transparent thin film for covering said circuit pattern are formed respectively; the light reflected by said portion of said wafer due to said irradiated light is detected; regions where the thickness of said optically transparent thin film on said wafer can be measured are determined, by using information for the spectral waveform data of the reflected light thus detected; and the film thickness of said optically transparent thin film in said regions where the film thickness can be measured is measured, by irradiating light onto the regions where the film thickness can be measured thus determined.

Moreover, in the present invention, light is irradiated onto a particular chip of a plurality of chips on a wafer formed with a plurality of chips whereon a circuit pattern and an optically transparent thin film for covering said circuit pattern are formed respectively; the light reflected by the particular chip region of said wafer due to said irradiated light is detected; a plurality of measurement points or regions for measuring the film thickness of said optically transparent thin film on said wafer are determined by using information for the spectral waveform data of the reflected light thus detected; the film thickness of said optically transparent thin film at said plurality of measurement points or regions is measured, by successively irradiating light onto the plurality of measurement points or regions thus determined; and the distribution of the film thickness of said optically transparent thin film from the information for the film thickness of the optically transparent thin film thus measured.

In order to achieve the object of film thickness measurement by fitting, in the present invention, a new model is hypothesized. That is, in cases where the dimension of the pattern formed on the sample being measured is equal to or smaller than the wavelength of the light used for measurement, a boundary region which accounts for the pattern edge region (pattern step region) is established, and the effects of this boundary region in fitting are taken into consideration.

Moreover, in order to achieve the object relating to selection of film thickness measurement points, measurement points heaving prescribed conditions are determined automatically on the basis of the design information, the measurement point periphery image, and the spectral waveform detected at the measurement points.

Furthermore, the processing conditions of the respective processing apparatuses in the semiconductor device manufacturing line are controlled on the basis of the film thickness information measured to a high degree of accuracy by the aforementioned fitting method.

### BRIEF DESCRIPTION OF THE DRAWINGS

FIG. 1 is an explanatory diagram showing one example of a spectral waveform detected in a region were film thickness measurement is possible;

FIG. 2 is an explanatory diagram showing one example of a spectral waveform detected in a region where film thickness measurement is not possible;

FIG. 3 is an explanatory diagram showing one example of the results of frequency analysis of a spectral waveform possible;

FIG. 4 is an explanatory diagram showing one example of the results of frequency analysis of a spectral waveform detected in a region were film thickness measurement is not possible;

FIG. 5 is an explanatory diagram showing one example of detecting the maximum value of a spectral waveform detected in a region where film thickness measurement is possible;

FIG. 6 is an explanatory diagram showing one example of detecting the maximum value of a spectral waveform detected in a region where film thickness measurement is not possible;

FIG. 7 is an explanatory diagram showing one example of fitting a logical waveform with respect to the spectral waveform detected in a region where film thickness measurement is possible;

FIG. 8 is an explanatory diagram showing one example of fitting a logical waveform with respect to the spectral waveform detected in a region where film thickness measurement is not possible;

FIG. 9 is an explanatory diagram showing one example of a measurement point investigation procedure according to an embodiment of the present invention;

FIG. 10 is an explanatory diagram showing one example of a measurement point investigation procedure according to an embodiment of the present invention;

FIG. 11 is an explanatory diagram showing one example of a measurement point investigation procedure according to an embodiment of the present invention;

FIG. 12 is an explanatory diagram showing one example of a measurement point investigation procedure according to an embodiment of the present invention;

FIG. 13 is an explanatory diagram showing one example of a measurement point investigation procedure according to an embodiment of the present invention;

FIG. 14 is an explanatory diagram showing one example of a measurement point investigation procedure according to an embodiment of the present invention;

FIG. 15 is an explanatory diagram showing one example of a film thickness measurement point investigate display according to an embodiment of the present invention;

FIG. 16 is an explanatory diagram showing one example of a film thickness measurement point investigate display according to an embodiment of the present invention;

FIG. 17 is an explanatory diagram showing one example of a film thickness measurement point investigate display according to an embodiment of the present invention;

FIG. 18 is an explanatory diagram showing one example of provisional reference measurement points before film thickness measurement point investigation according to an embodiment of the present invention;

FIG. 19 is an explanatory diagram showing one example of the results of determining film thickness measurement points according to an embodiment of the present invention;

FIG. 20 is an explanatory diagram showing one example of an operating screen for automatically determining film thickness measurement points according to an embodiment of the present invention;

FIG. 21 is an explanatory diagram showing one example of a window screen for confirming the provisional reference measurement points set according to an embodiment of the present invention;

FIG. 22 is an explanatory diagram showing one example of a measurement point determining process using image processing according to an embodiment of the present invention;

FIG. 23 is an explanatory diagram showing one example of a measurement point determining process using image processing according to an embodiment of the present invention;

FIG. 24 is an explanatory diagram showing one example of a measurement point determining process using image processing according to an embodiment of the present invention;

FIG. 25 is an explanatory diagram showing one example of a measurement point determining process using image processing according to an embodiment of the present invention;

FIG. 26 is an explanatory diagram showing one example of a measurement point determining process using image processing according to an embodiment of the present invention;

FIG. 27 is an explanatory diagram showing one example of a measurement point determining process using image processing according to an embodiment of the present invention;

FIG. 28 is an explanatory diagram showing one example of a measurement point determining process using image processing according to an embodiment of the present invention;

FIG. 29 is an explanatory diagram showing one example of a measurement point determining process using image processing or according to an embodiment of the present invention;

FIG. 30 is an explanatory diagram showing one example of a method for determining a small number of measurement points for controlling film thickness according to an embodiment of the present invention;

FIG. 31 is an explanatory diagram showing one example of the results of determining a small number of measurement points for controlling film thickness according to an embodiment of the present invention;

FIG. 32 is an explanatory diagram principally showing the composition of an optical measuring system for a film thickness measuring device according to an embodiment of the present invention;

FIG. 33 is an explanatory diagram showing one example of a manufacturing line for thin-film devices, employing a film thickness measuring device executing a film thickness measurement point determining method according to an embodiment of the present invention; and

FIG. 34 is an explanatory diagram showing one example of a parallel-processing CMP system, employing a film thickness measuring device executing a film thickness measurement point determining method according to an embodiment of the present invention.

FIG. 35 is a sectional view of a multi-layer film;

FIG. 36 is a sectional view of a measurement object which combines a plurality of layer structures;

FIG. 37 is a sectional view of a measurement object which combines two layer structures;

FIG. 38 is a front view showing the approximate composition of a condensing type optical detection system of a film thickness measuring apparatus according to the present invention;

FIG. 39 is a front view showing the approximate composition of a condensing type optical detection system of a film thickness measuring apparatus according to the present invention;

FIG. 40 is a plan view of a pattern showing the relationship between the measurement field of view and a pattern having larger dimensions than the detection wavelength;

FIG. 41 is a sectional view of a pattern illustrating a model equation setting method for a pattern having larger dimensions than the detection wavelength according to the present invention;

FIG. 42 is a plan view of a pattern showing the relationship between the measurement field of view and a pattern having smaller dimensions than the detection wavelength;

FIG. 43 is a sectional view of a pattern illustrating a model equation setting method for a pattern having smaller dimensions than the detection wavelength according to the present invention;

FIG. 44 is one example of calculation accuracy evaluation results for the surface area ratio calculated in the present invention, being a graph showing the relationship between the calculated surface area ratio and pattern surface area ratio within the measurement field of view;

FIG. 45 is a graph showing the relationship between the absolute value of the measurement error and the pattern surface area ratio in the measurement field of view according to the present invention;

FIG. 46 is a graph showing the relationship between reflectivity and wavelength, illustrating one example of results in a case where the boundary structure is taken into consideration, according to the present invention; and

FIG. 47 is a block diagram showing one example of the composition of a semiconductor device manufacturing line wherein the film thickness measurement results according to the present invention are reflected in the process conditions.

### DESCRIPTION OF THE PREFERRED EMBODIMENTS

The embodiment of the present invention relates to an example where the present invention is applied with respect to CMP in a manufacturing process for a semiconductor device and is used to control film thickness after processing of a film formed on a wafer surface.

Firstly, the method of measuring film thickness by fitting will be described.

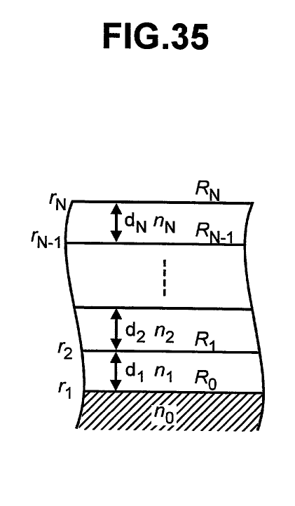

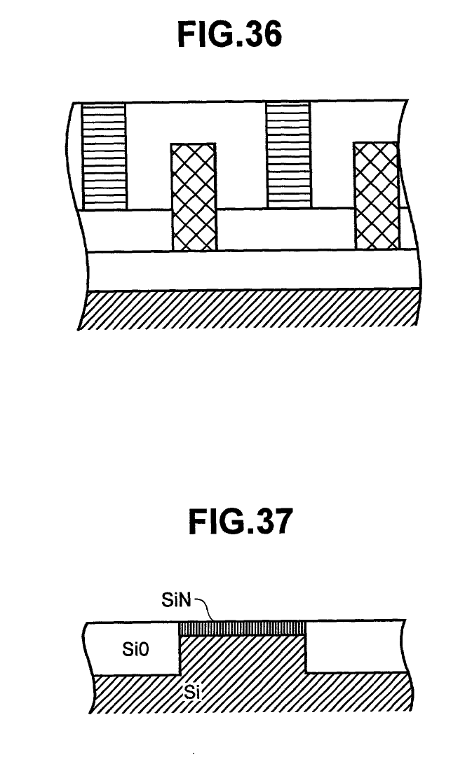

Fitting has been used conventionally for measuring film thickness. Supposing a film comprising a plurality of layers and having a uniform structure in the measurement field of view, as illustrated in FIG. 35, then provided that the film thickness and the material (refractive index and absorption coefficient) of each layer is already known, the surface reflectivity Rⱼ of layer j is expressed by the logic equation shown in Formula 1. In other words, the surface reflectivity R_{N} of the film can be determined by progressive application of Formula 1, starting from the bottom layer.

$$Rj = \frac{{r}_{j + 1} + {R}_{j - 1} {ⅇ}^{- 2 π i2dj \frac{{n}_{j}}{λ}}}{1 + {r}_{j + 1} + {R}_{j - 1} {ⅇ}^{- 2 π 2 dj \frac{{n}_{j}}{λ}}} \\ where \\ {r}_{j + 1} = \frac{{n}_{j + 1} - {n}_{j}}{{n}_{j + 1} + {n}_{j}} \cdot {R}_{0} = {r}_{1} \qquad [ Formula 1 ]$$

Rⱼ: surface reflectivity of jth layer

rⱼ: interface reflectivity of jth layer

nⱼ: refractive index of jth layer (complex refractive index)

dⱼ: film thickness of jth layer

Therefore, a logical refractive index is calculated, taking the film thickness of the measurement object as an unknown value, and the film thickness can then be derived by resolving this unknown value in such a manner that the error between the logical refractive index and the actually detected refractive index is a minimum. In some cases, the material of the film may also be set as an unknown value, in addition to the film thickness.

However, since it is hypothesized that the layer structure within the measurement field of view is uniform, this method cannot be applied to cases where the layer structure within the measurement field of view is not uniform. In order to be able to measure film thickness in cases where the layer structure within the measurement field of view is not uniform, it is necessary to hypothesize models in the form of logic equations wherein a plurality of layer structures are combined.

Here, it is supposed that two layer structures as shown in FIG. 37 are combined. FIG. 37 is a schematic diagram of the cross-section of the film to be measured.

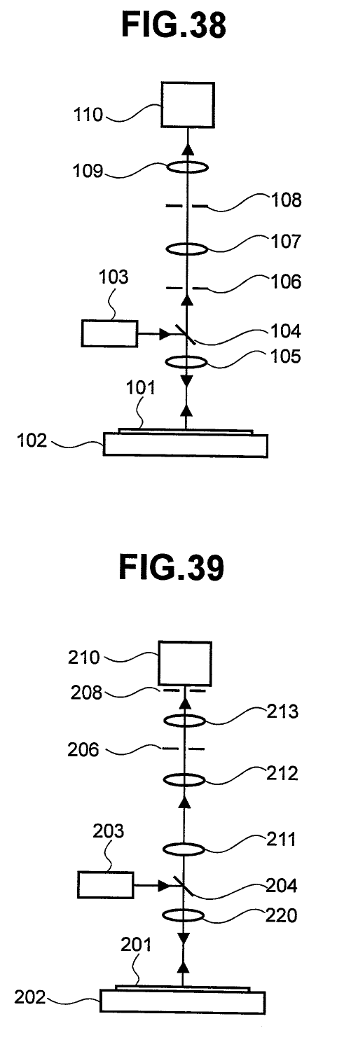

The logic equation differs according to the optical detection system and the complexity of the measurement pattern. Firstly, a condensing optical system as illustrated in FIG. 38 will be considered. The light from the light source 103 is formed into parallel light by the lens system 105 and irradiated onto the sample 101. The reflected light from the sample 101 is condensed by the lens system 105. A spatial filter 106 is provided at this position and transmits only the 0^{th} order light component of the reflected light. The spatial filter 106 has the effect of eliminating light scattered at the surface of the sample, and light diffracted by the pattern. The light passed by the spatial filter 106 is formed again into parallel light by the lens system 107, and is then focused by the lens system 109 and split by a beam splitter 110, whereby spectral data can be obtained. In this case, by inserting a field of view aperture 108 between the lens system 107 and the lens system 109, it is possible to set a detection region of a desired size.

In the case of this optical system, only the forward reflected light from the measurement field of view is focussed at one point, and hence the model equation is that shown in Formula 2.

|R|²=|a₁R₁+a₂R₂| [Formula 2]

where

a₁: surface area ratio of first layer structure in measurement field of view

a₂: surface area ratio of second layer structure in measurement field of view

R₁: surface area reflectivity of first layer structure alone

R₂: surface area reflectivity of second layer structure alone

Next, an image forming system such as that illustrated in FIG. 39 is considered as the optical system. The light emitted from the light source 203 is irradiated onto the sample 201 via an object lens 220. The light reflected from the sample 201 is focussed again via the lens system 211-213. By inserting a field of view aperture 208 at this focusing position, it is possible to set a detection region of a desired size.

The light is split by a beam splitter 210 and spectral data thereof is obtained. In this case, a spatial filter 206 is provided on the Fourier transformation face of the lens system 211-213, and by only transmitting 0^{th} order light, it eliminates the effects of scattered light from the surface of the sample, and light diffracted by the pattern, as above.

The model equation in the case of this optical system differs according to the size of the pattern being measured and the repetition width.

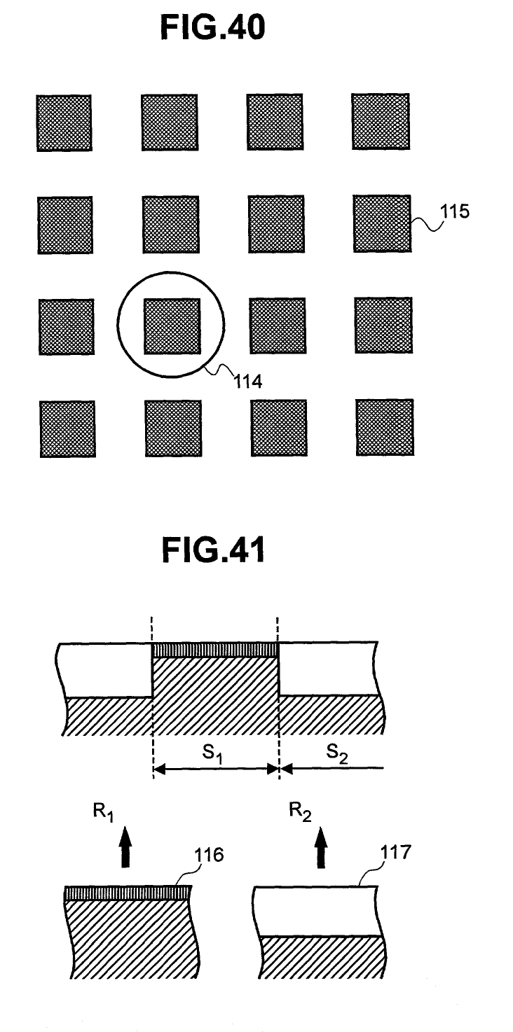

If the size of the pattern being measured and the repetition width are both sufficiently large in comparison to the detection wavelength, for example, if a repeated pattern 115 having a size of several μm as illustrated in FIG. 40 is measured in a measurement field of view of φ10 μm diameter, using a detection wavelength band of 400-800 nm, then the model equation will be as shown in Formula 3.

|R|²=a₁|R₁|+a₂|R₂|² [Formula 3]

When measuring a pattern of the order of several μm or above, as illustrated in FIG. 40, it is possible to consider the respective layer structures as independent structures (FIG. 41). In other words, in this case, it can be considered that there will be no interference between the reflected light from different points on the same plane, and hence the model equation, Formula 3, applies weightings to the surface reflectivity value for each respective independent layer structure, according to the ratio occupied by the corresponding layer in the measurement field of view (pattern area density values, a₁, a₂), and then adds together these reflectivity values.

On the other hand, in cases where the size of the pattern to be measured, or the repetition width, is equal to or less than the detection wavelength, for example, if measuring a repetition pattern 118 of size 1 μm or less as illustrated in FIG. 4 in a measurement field of view of φ10 μm diameter, using a detection waveband of 400-800 nm, then in contrast to the case illustrated in FIG. 40, the respective layer structures cannot be considered each as independent structures.

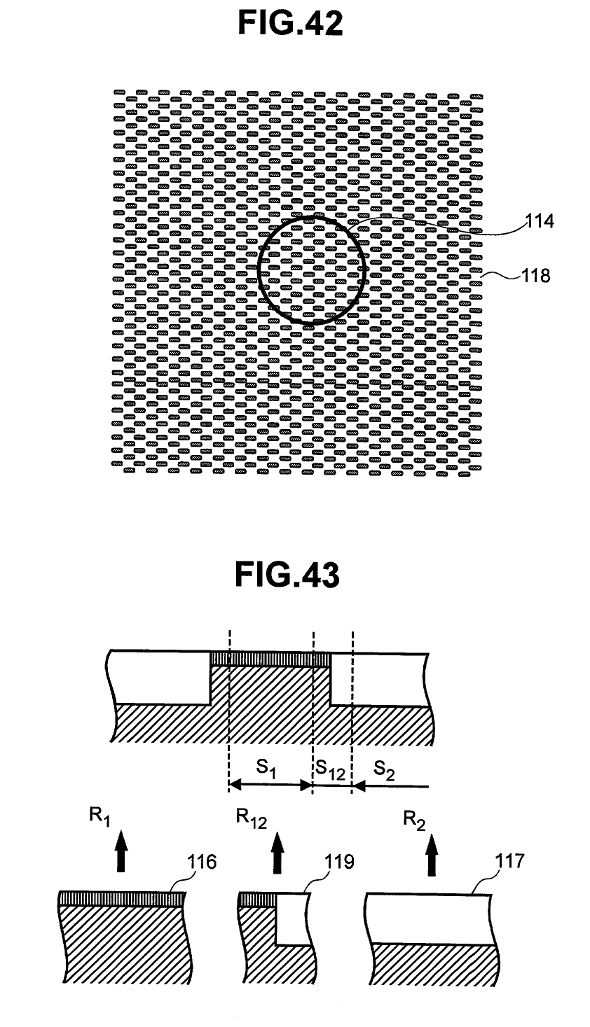

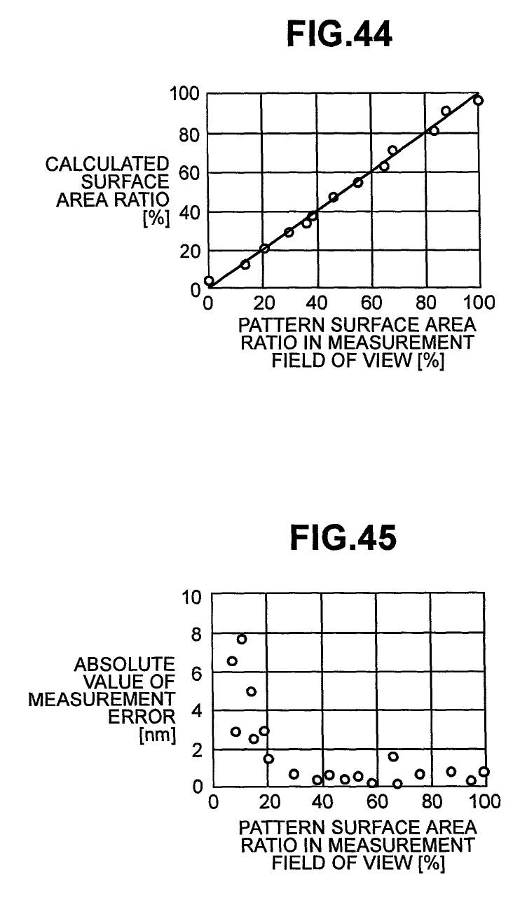

In the case illustrated in FIG. 42, it is necessary to consider an intermediate model equation between the two models shown in FIG. 37 and FIG. 41. In other words, it is necessary to consider the boundary structure where the two structures are combined, in addition to the respective independent layer structures. It is hypothesized that, in this boundary structure, there is mutual interference between the reflected light from different spatial positions. The model equation for the totality of the reflected light can be derived by adding weightings to the respective structures (including the boundary structure) according to the surface area ratio of each in the measurement field of view, and then finding the sum thereof, as in the model equation shown in Formula 4.

|R|²=a₁|R₁|²+a₂|R₂|²+a₁₂|R₁₂|² [Formula 4]

where

|R₁₂|²=|b₁R₁+b₂R₂|²

R₁₂: surface area reflectivity of boundary layer structure

b₁: surface area ratio of first layer structure in boundary structure

b₂: surface area ratio of second layer structure in boundary structure

By adopting the equation above as the model equation for fitting, according to the circumstances, it is possible to determine the prescribed film thickness.

In addition to the film thickness, it is also possible to set, as the parameter for fitting, the material of the film, or the surface area ratio of the respective layer structures in the measurement field of view.

Desirably, the surface area ratio of each layer structure is set in advance. However, situations where error arises in the calculation results can be imagined if there is a difference between the set surface area ratio and the actual surface area ratio, due to misalignment of the measurement field of view, or the like. Therefore, if the surface area ratio is to be derived as a parameter of the fitting method, then it does not need to be set in advance, and furthermore, the occurrence of error due to positional misalignment, or the like, can be prevented.

If the film material is set as the parameter, then an approximation equation such as the Cauchy equation shown in Formula 5 which incorporates information relating to the material (refractive index, absorption coefficient, and the like) should be used.

n=n₀/λ⁰+n₁/λ²+n₂/λ⁴+n₃/λ⁶+n₄/λ⁸

n=k₀/λ⁰+k₁/λ²+k₂/λ⁴+k₃/λ⁶+k₄/λ⁸ [Formula 5]

where

λ: wavelength

n: refractive index

n₀-n₄: coefficient (refractive index)

k: absorption coefficient

k₀-k₄: coefficient (absorption coefficient)

Generally, the method used to determine a parameter by fitting is the ‘method of least squares’. If the model equation is complex, as in Formula 2 to Formula 4, then in many cases, a non-linear method, such as the Rabenberg Macquart method, or the like, is adopted.

Furthermore, even in cases where the number of combined layer structures is three or more, the present equations can still be used to determine the film thickness of a particular film. If Formula 2, Formula 3 and Formula 4 are expanded and standardized in the case of three or more layer structures, then the resulting equations are as shown respectively in

|R|²=|ΣaₘRₘ|² [Formula 6]

where

m: number of structures

aₘ: surface area ratio of mth layer structure in measurement field of view

Rₘ: surface reflectivity for mth layer structure alone

|R|²=Σaₘ|Rₘ|² [Formula 7]

|R|²=Σaₘ|Rₘ|²+Σa_{pq}|R_{pq}|²+Σa_{uvw}|R_{uvw}|²+ [Formula 8]

where

|R_{pq}|²=|bₚRₚ+b_{q}R_{q}|²

|R_{uvw}|²=|bᵤRᵤ+bᵥRᵥ+b_{w}R_{w}|²

a_{pq}: surface area ratio of boundary structure between pth and pth layer structures in measurement field of view

R_{pq}: surface reflectivity of boundary structure between pth and qth layer structures

a_{uvw}: surface area ratio of boundary structure of three structures, the uth, vth and wth layer structures, in the measurement field of view;

R_{uvw}: surface reflectivity of boundary structure of three structures, the uth, vth and wth layer structures

bₚ: surface area ratio of pth layer structure in boundary structure between pth and qth layer structures;

b_{q}: surface area ratio of qth layer structure in boundary structure between pth and qth layer structures;

bᵤ: a surface area ratio of uth layer structure in boundary structure between three structures the uth, vth and wth layer structures;

bᵥ: surface area ratio of vth layer structure in boundary structure between three structures, the uth, vth and wth layer structures;

b_{w}: surface area ratio of wth layer structure in boundary structure between three structures, the uth, vth and wth layer structures;

Desirably, the number of parameters to be fitted is small, as they affect the calculation time and the calculation error. However, in the case of three structures or more, and particularly, in the case of Formula 8, the number of parameters is very high. The overall number of parameters can be reduced by ignoring factors which have little influence, such as structures occupying a very small surface area ratio in the measurement field of view, or, if one film thickness is to be derived as a function containing another film thickness as a variable, by introducing the aforementioned function instead of the film thickness as a fitting parameter.

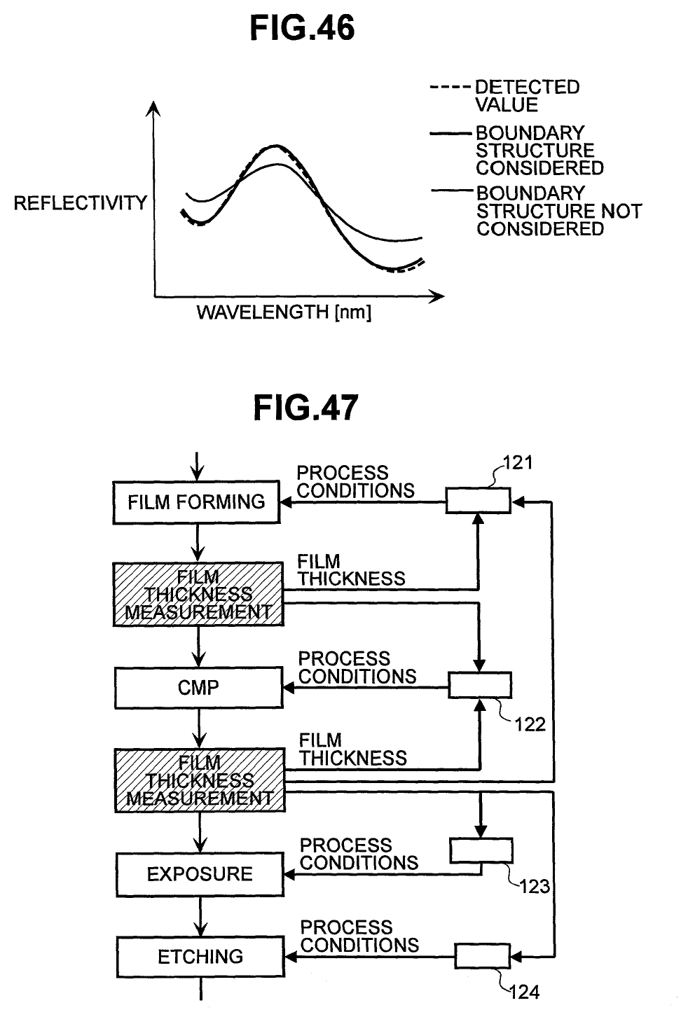

FIG. 46 shows a comparison between a case where the boundary structure is considered, and a case where it is not considered, when detecting light from the measurement object illustrated in FIG. 37 by means of light of the same waveband. As FIG. 46 reveals, by taking the boundary structure into consideration, the error between the detected value and the logic value is reduced.

Although it also depends on the structure of the measurement object if the boundary structure is taken into consideration, it is possible to obtain a measurement accuracy of 10 nm or less for an object of the order of 100 nm, or if the conditions are adjusted, a measurement accuracy of approximately 1-4 nm. If the boundary structure is not taken into consideration, then for the reasons stated above, the measurement accuracy declines and the error rises from the approximately 10-20 nm to several 10 nm, and in the worst cases, fitting to the detected value become impossible and measurement cannot be performed.

As the measurement object becomes smaller with respect to the detection waveband, the ratio of the measurement field of view occupied by the boundary region increases. Therefore, when measuring film thickness in finely detailed patterns of 1 μm or less using an imaging optical system, it is imperative that the boundary structure is taken into consideration in the fitting calculation.

Next, a method is described for determining measurement points for measuring film thickness of a transparent thin film on a circuit pattern buried under an optically transparent thin film, with respect to a wafer which has undergone a CMP stage in a semiconductor device manufacturing process.

In Japanese Patent Laid-open No. 2000-9437 described above, it is disclosed that the film thickness distribution in a chip can be determined by utilizing the fact that the film thickness can be measured in any part of the pattern, provided that the pattern area ratio within the measurement field of view is equal to or above a certain value. By using this method, even an operator of little expertise is able to evaluate the film thickness distribution within the chip or wafer, accurately, (for detailed description of the film thickness measurement method, and the like, see Japanese Patent Laid-open No. 2000-9437.) However, in the technique in Japanese Patent Laid-open No. 2000-9437, if, for example, a chip is being measured at a total of 10×10=100 points, then it has been necessary for an operator to determine each respective measurement point.

In one embodiment of the present invention, the light is irradiated onto a wafer surface, the light reflected from the wafer is detected, and measurement points for measuring the film thickness are determined on the basis of the spectral waveform data of the reflected light thus reflected. Details of this method are described below.

In automatically determining measurement points for measuring the film thickness of a transparent film on a circuit pattern buried under an optically transparent thin film, it is necessary to judge whether or not a measurement point is over the prescribed pattern and has a pattern area ratio that is sufficient for performing measurement. This judgement is made by analyzing the spectral waveform detected in the proposed measurement region.

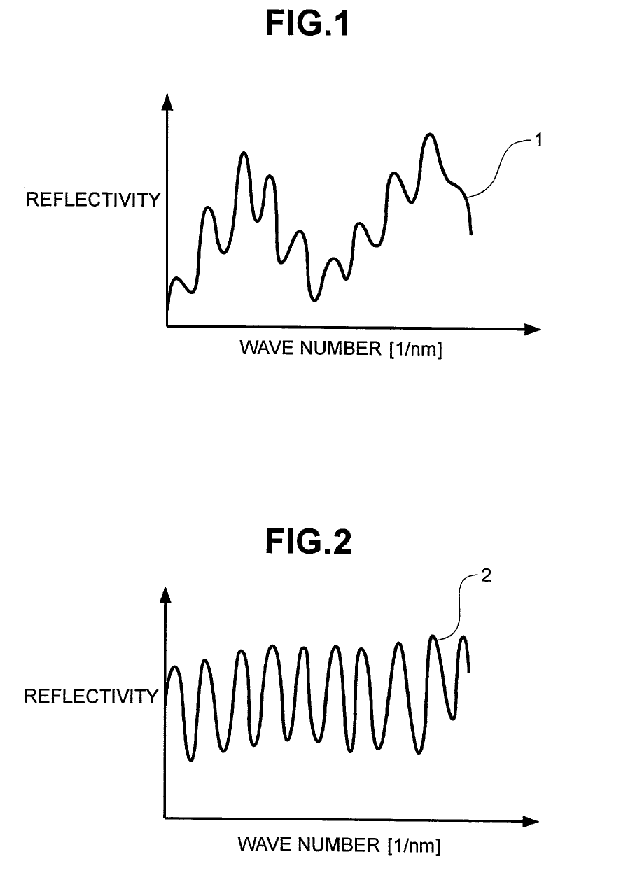

Spectral waveforms detected in regions where measurement is possible have respectively different characteristics from those detected in regions where measurement is not possible. For example, FIG. 1 and FIG. 2 respectively show typical examples of spectral waveforms detected in a measurable region and a non-measurable region, in the case of a sample which has undergone a CMP stage in an LSI wiring process. FIG. 1 shows spectral waveform 1 for reflected light from a measurable region, and FIG. 2 shows waveform 2 for reflected light from a region that is troublesome to measure.

The characteristic of the waveform in FIG. 1 is a waveform comprising a superimposed low frequency component and high frequency component. On the other hand, the characteristic of the waveform in FIG. 2 is that the high frequency component in FIG. 1 is dominant and the low frequency component is scarcely discernable. This disparity is due to the difference between a case where the interference component produced by the reflected light from the pattern is dominant, and a case where the interference component produced by the reflected light from the lower layer is dominant.

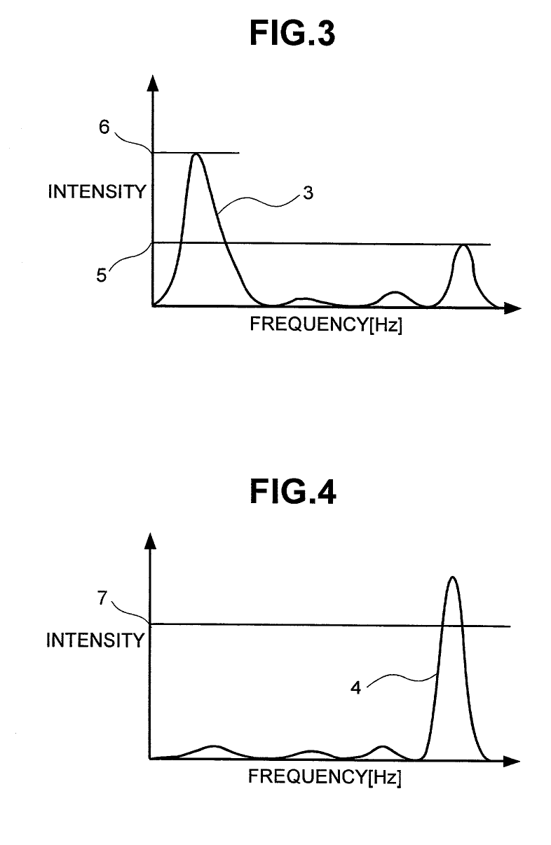

This difference in waveform characteristics can be taken as a difference in frequency components. Therefore, by frequency analysis of the waveform, the characteristics can be extracted and it can be judged whether or not measurement is possible. Item 3 in FIG. 3 and item 4 in FIG. 4 indicate the results of frequency analysis relating to FIG. 1 and FIG. 2, respectively. As a method for determining whether or not measurement is possible from these results, it is possible, for example, to calculate the ratio between the intensity 5 of the high frequency component and the intensity 6 of the low frequency component in FIG. 3, compare this ratio with a predetermined threshold value, and designate the region to be measurable if the ratio exceeds the threshold value, and designate it to be non-measurable if the ratio does not exceed the threshold value.

Moreover, as shown in FIG. 4, it is also possible to conceive a method hereby the intensity of the high frequency component is compared with a predetermined threshold value 7 and the region is designated as measurable if the intensity exceeds this threshold value, and non-measurable if it does not. Frequency analysis methods, such as FFT (Fast Fourier Transform), MEM (Maximum Entropy Method), and the like, may be used for analysing the light frequency.

Furthermore, instead of frequency analysis, it is also possible to adopt a judgement method based on extracting the periodicity of the waveform, by calculating the self-correlation function thereof.

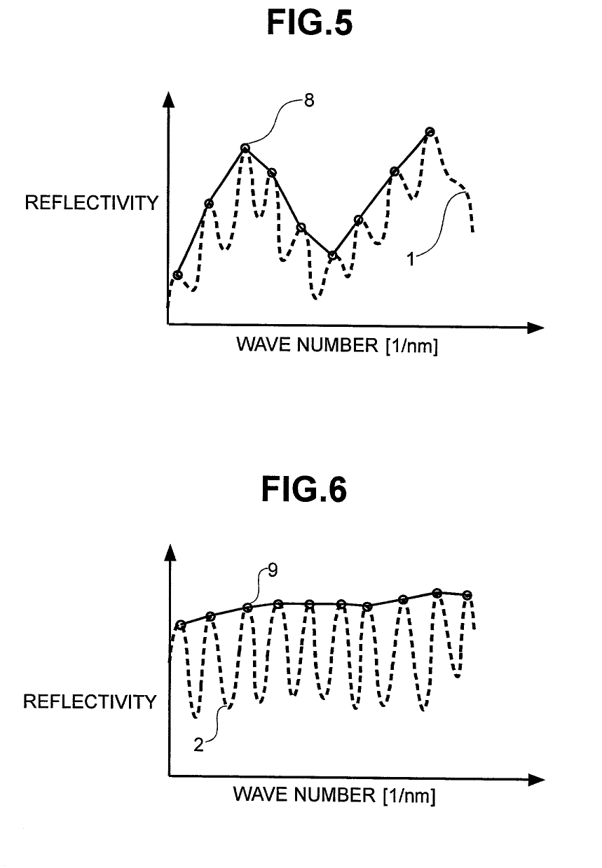

A method such as that illustrated in FIG. 5 and FIG. 6, which does not relate to waveform periodicity, might also be adopted. In this method, for example, the maximum values 8, 9 of the waveform are extracted, and judgement is made by comparing the magnitude of the variation in these maxima with a predetermined threshold value. More specifically, since the spectral waveform for a region where film thickness measurement is possible has a large low frequency component, then the variation in maxima will be large in the case of a measurable region, and conversely, this variation will be small in the case of a non-measurable region.

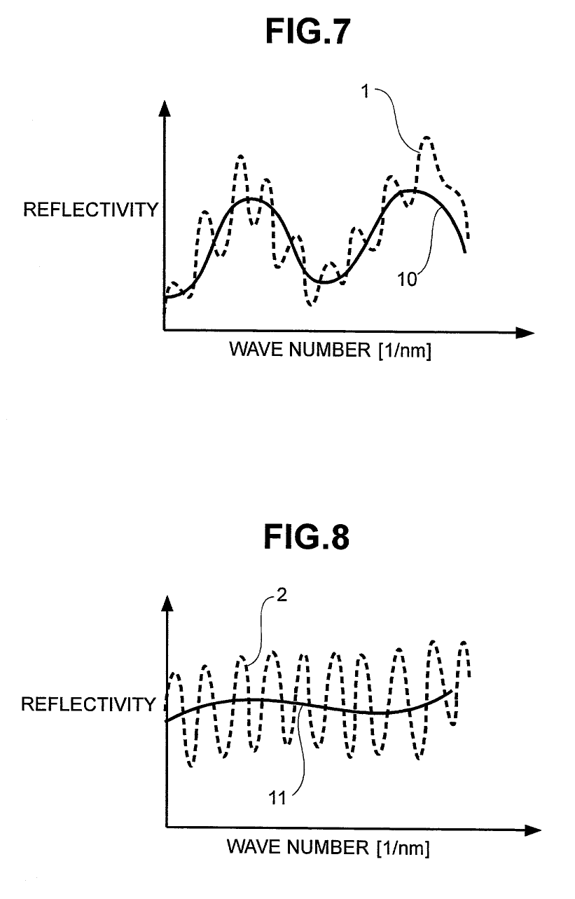

Furthermore, if the structure to be measured is already known, then a method can be adopted which judges measurement points by means of fitting with respect to a logical waveform. For example, this judgement can be made by fitting a logical spectral waveform calculated from the structure situated over the pattern only onto the detected spectral waveform. Moreover, it is also possible to conceive of a method wherein previous values for the film thickness of the structure to be measured are known and a range including these values is set, waveform fitting is performed within this range, and the region is designated as measurable if the fitting error (for example, the square-sum of the error between the two waveforms) is equal to or less than a certain threshold value, and otherwise, it is designated as non-measurable. FIG. 7 and FIG. 8 show examples of cases where wavelength fitting has been performed. In FIG. 7, the error with respect to the fitted waveform 10 is relatively small, whereas in FIG. 8, this error is large.

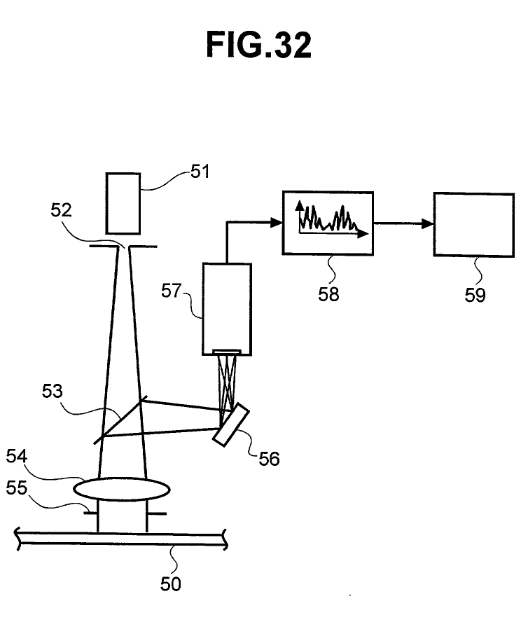

FIG. 32 principally shows the composition of an optical measurement system of a measuring device for performing judgement by detecting and analysing spectral waveforms. This measuring device is also used as a film thickness measuring device. In practice, the film thickness measuring device also comprises an XY stage, a stage drive system, input operating section, and a control section for controlling the whole device, and the like, but these components are omitted from the illustration in FIG. 32.

In FIG. 32, numeral 50 denotes a wafer, 51 is a white light source consisting of a halogen lamp, or the like, 52 is a pin hole, 53 is a beam splitter, 54 is a lens, 55 is an aperture, 56 is a diffraction lattice, 57 is a detector, 58 is a processing circuit, and 59 is a display device.

White light emitted from the white light source 51 passes through the pin hole 52 and beam splitter 53, is converted to parallel light rays by the lens 54 and then passes through the aperture 55, where it is irradiated onto the film to be measured on the surface of the wafer 50. The light reflected by the wafer 50 passes through the aperture 55 and lens 54, the light path thereof is then changed by the beam splitter 53, and it is irradiated onto the diffraction lattice 56. The light split by the diffraction lattice 56 is focused on the detector 57, by the spectral waveform thereof can be derived. The processing circuit 58 executes judgement processing by means of a judgement algorithm such as the foregoing, and the judgement results and spectral waveform data can be viewed on the display device 59, as and when necessary. The judgement results are stored in storing means (not illustrated) in correspondence with co-ordinate values from a reference position on the chip, as derived by referring to the movement position of the XY stage on which the wafer 50 is mounted.

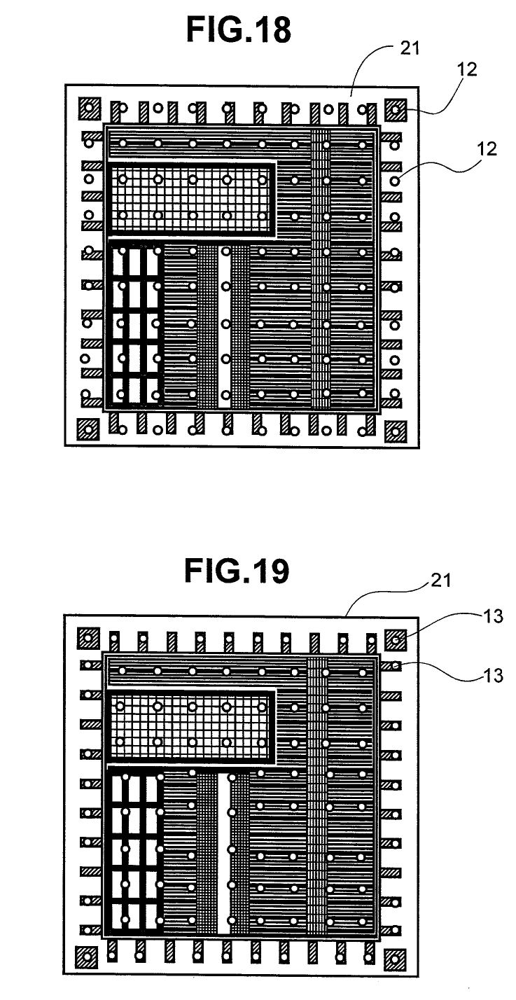

Next, a method for automatically investigating and determining measurement points on the basis of the aforementioned judgement method will be described. For example, as illustrated in FIG. 18, in the case of measuring the film thickness at 10×10=100 points on one chip, the respective provisional reference at points 12 that are previously set are not necessarily measurable points. Therefore, if a provisional reference measurement point 12 is in fact a non-measurable point, then it is necessary to set a measurable point located adjacently to the provisional reference measurement point 12, as a measurement point. In FIG. 18, numeral 21 indicates an image of one chip.

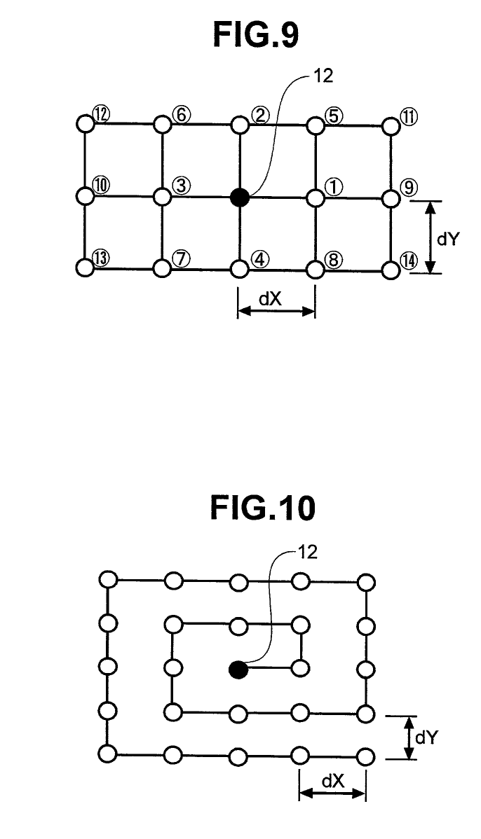

FIG. 9-FIG. 14 are diagrams showing examples of a procedure for investigating measurement points. FIG. 9 and FIG. 10 illustrate cases where the spectral waveform is detected successively at respective points, and measurability is judged, by setting the number of investigate points and the interval between investigate points in the horizontal direction X and vertical direction Y.

FIG. 9 illustrates a case where a total of 15 points, namely, 5 points in the X direction spaced at interval dX and 3 points in the Y direction spaced at interval dY, are investigated, wherein, firstly, a reference measurement point 12 is investigated (the spectral waveform thereof is detected and judged), whereupon the investigation is continued in successive fashion starting from points adjacent to the reference measurement point 12.

In the case of FIG. 10, a total of 25 points are investigated, five each in the X and Y directions, at respective intervals of dX and dY, a provisional reference measurement point 12 being investigated (by detecting and judging the spectral waveform thereof) first, whereupon the respective points are investigated successively in square spiral fashion from the provisional reference measurement point 12.

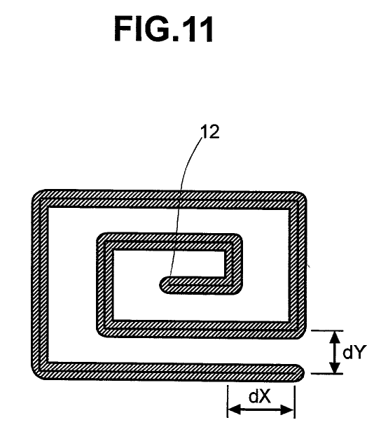

In the respective cases of FIG. 9 and FIG. 10, it is also possible to set the first point judged to be measurable as a result of the investigation, as the measurement point for measuring the film thickness, halting any investigation of subsequent points, or alternatively, it is also possible firstly to detect and judge the spectra of all of the investigation points, and then to set the most suitable point from the judgement results, or the nearest measurable point to the provisional reference measurement point 12 (or provisional reference measurement point 12 itself if it is a measurable point), or the point which best satisfies both conditions, as the measurement point for performing film thickness measurement. This applies similarly to the cases of FIG. 11 to FIG. 14 below.

Furthermore, if the spectral detection and judgement processes can be performed at high-speed, then it is also possible, as shown in FIG. 11, to perform spectra detection and judgement in real time by performing continuous investigation following a square spiral path such as that FIG. 10, instead of performing intermittent investigation as described in FIG. 9 and FIG. 10.

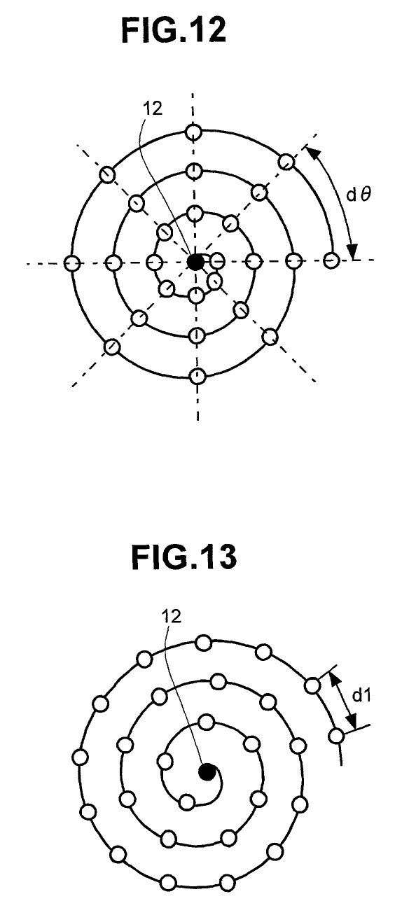

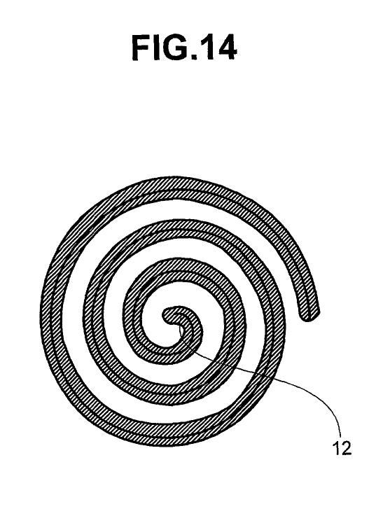

FIG. 12-FIG. 14 illustrate cases where the processing performed in a square spiral fashion in FIG. 10 and FIG. 11 is conducted in a circular spiral fashion. FIG. 12 illustrates an example where respective points previously determined at intervals of dθ on a path of travel are investigated in an intermittent fashion, and FIG. 13 illustrates an example where respective points previously determined at intervals of a movement distance d1 on a path of travel are investigated in an intermittent fashion. Moreover, FIG. 14 illustrates a case where investigation is performed in continuous fashion along the same path of travel as FIG. 12 and FIG. 13, light detection and judgement being carried out in real time.

The investigation of the prescribed region in the vicinity of the provisional reference measurement point 12, taking this provisional reference point 12 as an origin, may be conducted in various ways other than the examples described above, for example, it may also be conducted in the fashion of similarly-shaped concentric quadrilaterals, or in concentric circular fashion.

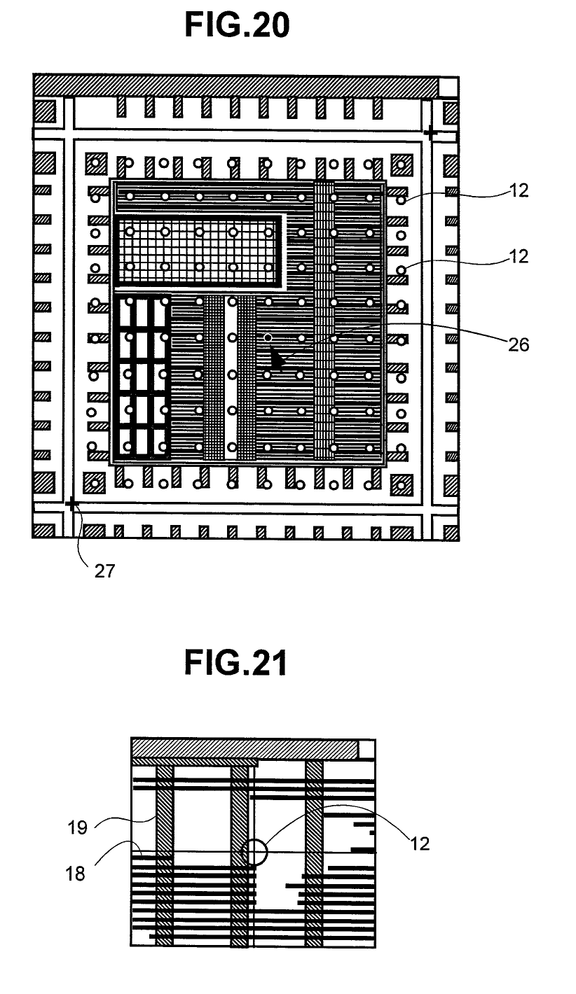

The aforementioned processing for automatically investigating (performing spectral detection and judgement) and determining measurement points is conducted at all the provisional reference measurement points 12 and the respective vicinities thereof, and as shown in FIG. 19, a total of 10×10=100 measurement points 13 are determined on one chip. The co-ordinate values for each measurement point 13 thus determined are stored in storing means (not illustrated), in the form of positional co-ordinates from a reference point (reference position mark) 27 (see FIG. 20) on that chip, for example.

Here, since each chip on the single wafer comprises the same thin film device, the operation of automatically setting measurement points 13 may be conducted for each chip, or it may be conducted for a plurality of chips which are to be subjected to film thickness measurement, or, depending on circumstances, it may be conducted one for all the chips. Furthermore, for wafers comprising the same product, it is possible to carry out the process of automatically determining measurement points for the first wafer (first wafer chip) only, and to apply the respective measurement point co-ordinates determined from the first wafer to the subsequent wafers, but according to requirements, it is also possible to implement a process of automatically redefining the measurement points for the wafers, at a suitably selected timing.

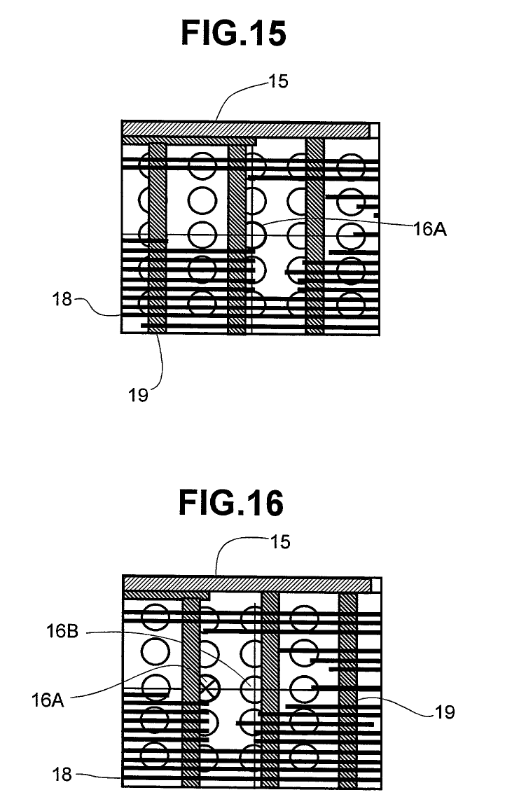

FIG. 15-FIG. 17 show schematic illustrations of a display screen of an investigation region, in a case where the process of automatically defining measurement points as described above was actually implemented by the measuring device (film thickness measuring device) shown in FIG. 32. In FIGS. 15 to 17, examples are shown according to the investigation sequence shown in the preceding FIG. 10.

In FIG. 15-FIG. 17, 15 is an investigation screen display window; and 16A-16G are investigation points (unit investigation regions for performing spectral detection and judgement). Moreover, the horizontal black bar markings represent a circuit pattern 18 buried in an optically transparent thin film forming an uppermost layer, and the vertical grey bar markings indicate a circuit pattern 19 buried in a lower transparent film being the thin film that is to be subjected to film thickness measurement.

FIG. 15 illustrates a case where investigation points 16A corresponding to provisional reference measurement points 12 are investigated, and in this case, since the purpose is to measure the thickness of the transparent film on the circuit pattern 18 indicated by the black horizontal bars, the judgement result at the first investigation point 16A will show a zero pattern surface ratio of circuit pattern 18, and hence this point will be judged to be invalid for film thickness measurement, as a result of the spectral waveform analysis and judgement; (without providing a detailed explanation here, the spectral waveform containing the light component reflected by the aforementioned circuit pattern 19 in the lower layer differs greatly from the spectral waveform in the case of the circuit pattern 18, and therefore it can readily be extracted and disregarded by the processing and judging means.)

FIG. 16 illustrates a situation where the next investigation point 16B is being investigated. The judgement result at this investigation point 16B, similarly to the judgement result for the investigation point 16A, is that film thickness measurement is not possible. In the diagrams, the “x symbol within a circle indicates investigation points for which a judgement result of ‘measurement not possible’ is returned.

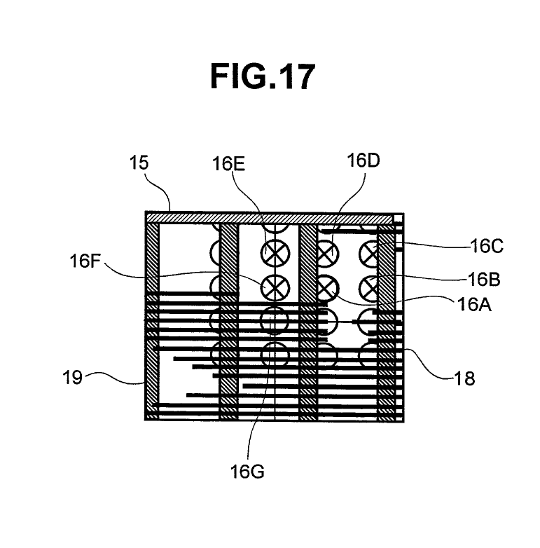

FIG. 17 shows a situation where, investigation points 16C-16F have been investigated and similarly judged to be invalid for measurement, and investigation point 16G is now being investigated. In the situation in FIG. 17, the pattern surface ratio at investigation point 16G is equal to or greater than a prescribed value, and therefore it is judged from the spectral waveform analysis and judgement process, that film thickness measurement is possible at this point. Thereafter, if all the investigation points are to be investigated, then a similar process is conducted for each of the remaining investigation points.

By respectively performing the investigation described above in the vicinity of each of the provisional reference measurement points 12 at the 100 points in the image 21 of the whole chip in FIG. 18, a total of 100 measurement points 13 which are guaranteed to a pattern area ratio of the prescribed value or above are determined on the chip, as shown in FIG. 19.

FIG. 20 is a schematic illustration of an example of an operating screen, in a case here the aforementioned measurement points are determined automatically, and this diagram depicts a situation where the image for one chip extracted by a suitable enlarging and imaging device is displayed on a suitable display device. An operator (worker) refers to the display screen shown in FIG. 20 and, by using a cursor 26, or the like, causes a reference point 27 of the chip, for example, to be recognized and stored in the control section of the measuring device shown in FIG. 32, whereupon, taking this reference point 27 as an origin, the operator sets and stores, for example, 10×10 provisional reference measurement points 12, by inputting co-ordinate values via a keyboard, or by operating the cursor, or the like. Thereupon, measurement points 13 for measuring the film thickness are automatically determined at 10×10 point by executing the series of steps described above. Consequently, the provisional reference measurement points 12 may be set readily in a rough fashion, such as equidistantly, and hence the burden on the operator is extremely light. FIG. 21 is an example of a window screen for confirming the provisional reference measurement points 12 once set.

Moreover, it is also possible for an operator to determine the points manually, rather than determining them automatically. In this case, for example, a desired point is selected by the cursor 26, or the like, as shown in FIG. 20, an expanded image of that section is displayed (see FIG. 21), and in this state, the operator controls the XY stage, or the like, to determine the measurement points. This is similar to the prior art, but in order to judge whether or not film thickness measurement is possible, the spectral waveform analysis and judgement processing according to the present embodiment described above is performed at any position, and a suitable measurement points can be determined by taking this as reference information for setting measurement points.

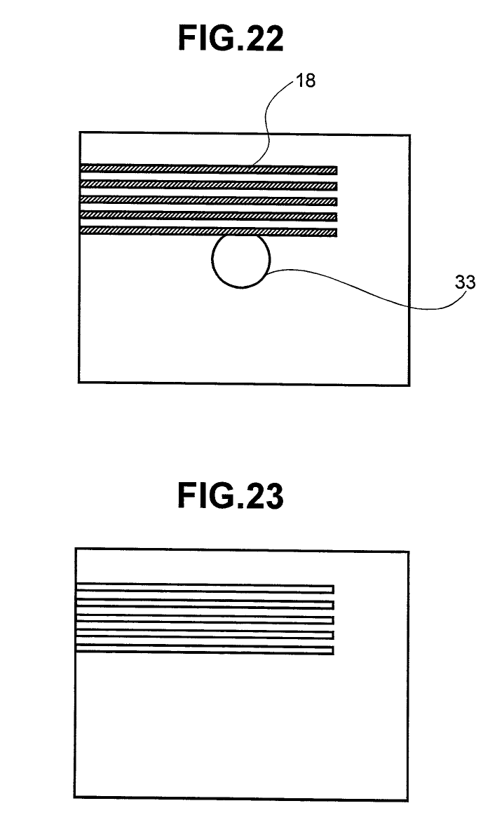

Next, a further embodiment of the present invention is described. This embodiment automatically determines measurement points for film thickness measurement by suitably processing image data captured in the vicinity of a predetermined provisional reference measurement point. FIG. 22 to FIG. 29 shows one example of a processing sequence for performing judgement processing on the basis of the image of the vicinity of a provisional reference measurement point captured as an enlarged image. The provisional reference measurement points are set in a similar manner to the foregoing embodiment.

FIG. 22 gives a schematic illustration of an image of the vicinity of a provisional reference measurement point. In FIG. 22, the circuit pattern 18 indicated by the black horizontal bars is a pattern buried under an uppermost optically transparent thin film, and the object here is to measure the thickness of the transparent film on this circuit pattern 18. Furthermore, the small circle 33 indicates a measurement field regions for measuring the film thickness, which is centred on the provision reference measurement point. In the case of FIG. 22, the measurement field region 33 is not positioned over the circuit pattern, and therefore it is judged that film thickness cannot be measured.

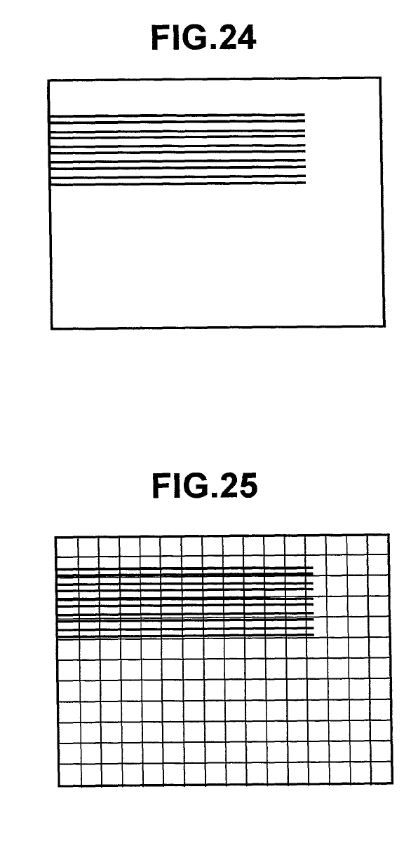

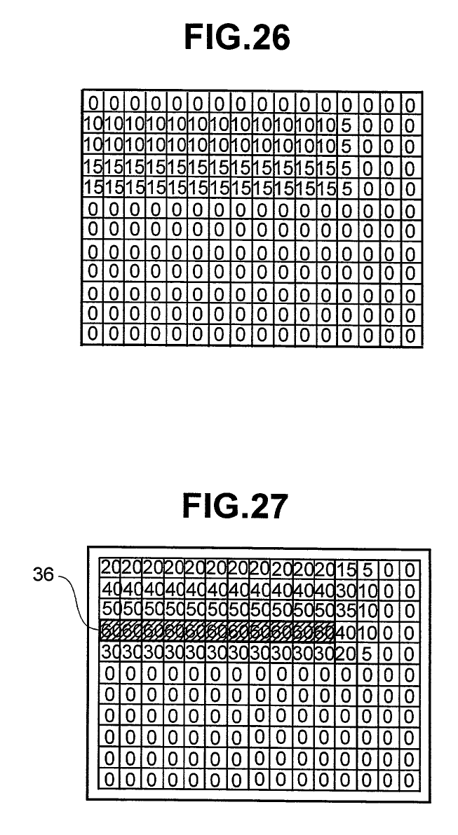

Therefore, edge detection processing is performed with respect to the image in FIG. 22, as illustrated in FIG. 23, whereupon horizontal line extraction processing is performed, as illustrated in FIG. 24. Furthermore, in order to investigate the distribution of the horizontal lines thus extracted, the image region in FIG. 24 is divided up as illustrated in FIG. 25, whereupon the distribution of horizontal lines within each division is converted to a numerical(quantized), as illustrated in FIG. 26, and then weightings for the local density distribution of the horizontal lines are applied, using a suitable statistical calculation method, or the like, as illustrated in FIG. 27, whereby the most suitable regions 36 are determined, wherein it is sufficiently guaranteed that the pattern area ratio of the circuit pattern 18 will exceed a prescribed value.

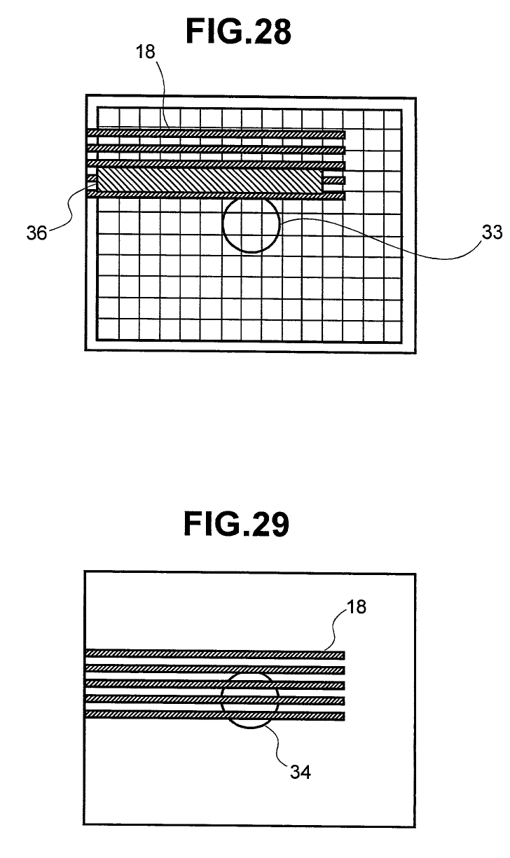

FIG. 28 shows an image wherein the candidate regions 36 determined as illustrated in FIG. 27 are combined with the screen showing the circuit pattern 18 in FIG. 22. In this state, by determining the amount of movement detected when the XY stage is moved to control the regions 36 so that they enter within the measurement field region 33, or the amount of movement required in the position of the measurement field region 33 in FIG. 28 (FIG. 22) until the measurement field region 33 overlaps with fields 36, it is possible automatically to define the measurement points where film thickness measurement is possible, from the amounts of movement thus determined, and the central co-ordinates of the measurement field region centred on the provisional reference measurement point in FIG. 22 (co-ordinates of the provisional reference measurement point). FIG. 29 illustrates the relationship between the circuit pattern and the measurement field region 34 centred on an automatically determined measurement point.

A further embodiment of the present invention is now described. This embodiment automatically determines measurement points for measuring film thickness by data processing, such as suitable image processing, of the previously determined design data for the vicinity of a provisional reference measurement point. The provisional reference measurement point is set in a similar manner to the foregoing embodiments, by incorporating design data, such as the CAD data for a chip, and displaying this data on a screen.

In this embodiment, instead of the captured image data, the CAD data for the circuit pattern buried under the uppermost optically transparent thin film is obtained, after which the measurement points where film thickness measurement can be performed are determined automatically by similar processing to that illustrated in FIG. 22 to FIG. 29.

According to the three embodiments described above, it is possible to determine a plurality of measurement points on a chip for measuring film thickness, swiftly and accurately, on the basis of clear, general judgement criteria, without being dependent on the experience or expertise of the operator. Therefore, it is possible to assess the thin film distribution within the chip surface, or the wafer surface, accurately, regardless of the expertise of the operator.

Next, a method for accurately managing film thickness by means of a small number of measurement points is described. Firstly, the film thickness is measured respectively at the measurement points determined by the method described above. In this case, the film thickness measurement method is the same as the method used to determine the measurement points described above. The measurement results can be conveyed to the operator by displaying the measured film thickness distribution in the chip surface or the measured film thickness distribution in the wafer surface, on a monitor screen.

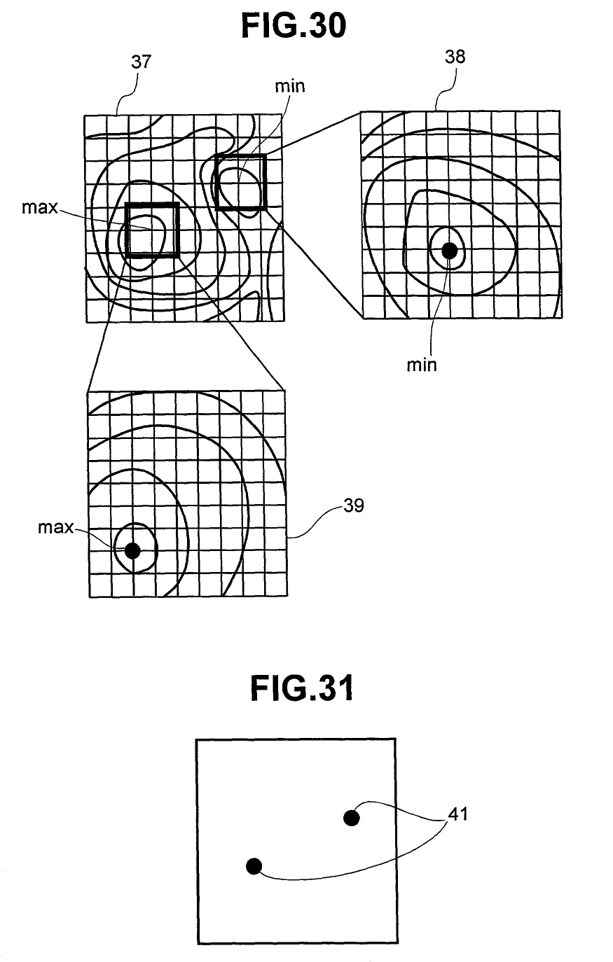

The film thickness can be controlled by evaluating the film thickness distribution of each of the measurement points thus obtained. In this case, to manage the film thickness accurately using a small number of measurement points, it is most efficient to measure two points, namely, the maximum and minimum point of the film thickness. In FIG. 30, numeral 37 is an illustration where the film thickness distribution in one chip is indicated by contour lines, based on the measurement results for 10×10=100 points, for example, and the sections indicated by max and min denote the regions of maximum and minimum film thickness. Therefore, as shown in FIG. 31, these max and min points should be selected as the minimum number of measurement points 41 for controlling the film thickness in the chip. Furthermore, if more accurate evaluation is required, then as indicated by the enlarged diagrams 38, 39 in FIG. 30, it is possible to achieve more precise control by assessing the film thickness in the respective max and min regions at fine intervals, in order to determine the position of the maximum and minimum film thickness. It is also possible to use evaluation points outside the maximum and minimum regions of film thickness, in order to control the film thickness using a small number of measurement points.

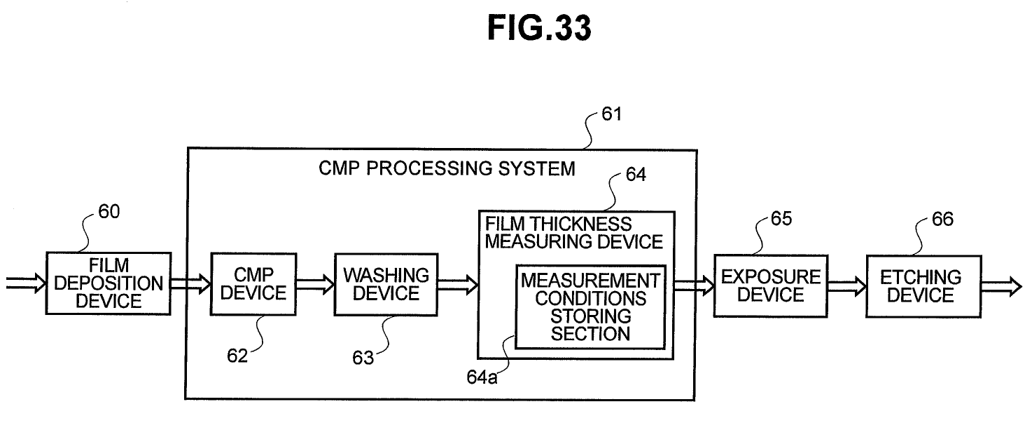

FIG. 33 is a diagram showing a manufacturing line for thin film devices to which the measuring device in FIG. 32, in other words, a film thickness measuring device, is applied. In the example depicted here, this device functions both as a device for determining measurement points for performing film thickness measurement and as a film thickness measuring device.

In FIG. 33, 60 is a film deposition device, 61 is a CMP processing system comprising a CMP device 62, washing device 63 and film thickness measuring device 64, 65 is an exposure device, and 66 is an etching device.

A wafer (not illustrated) is repeatedly subjected to film deposition, CMP processing, exposure, etching, and the like, whereby the respective chips are fabricated thereon as thin film devices. After the first wafer for a certain product has been film deposited by the film deposition device 60, levelled by the CMP device 62 and washed by the washing device 63, it is transferred to the film thickness measuring device 64. Here, the operator observes an image of the chip displayed on the display of the film thickness measuring device 64, and sets provisional reference measurement points as described above, whereupon he or she instructs the film thickness measuring device 64 to implement a process for automatically determining the measurement points for performing film thickness measurement. Receiving this instruction, the film thickness measuring device 64 executes processing for automatically determining the measurement points, as described above, in accordance with a previously defined measurement point determining algorithm. The data for each measurement point thus obtained is stored in a measurement condition storing section 64a, along with other measurement conditions. Thereupon, the film thickness measuring device 64 measures the film thickness at each measurement point, using the data for each measurement point stored in the measurement conditions storing section 64a, by means of a similar method to that disclosed in Japanese Patent Laid-open No. 2000-9437 described above, and it determines the film thickness distribution. Next, the wafer undergoes suitable processing for fabricating thin film devices, by means of the exposure device 65, etching device 66, and the like.

When the next wafer of the same product is transferred to the film thickness measuring device 64, the film thickness measuring device 64 immediately measures the film thickness at the respective measurement points using the data for the measurement points stored in the measurement conditions storing section 64a, and it then conducts processing for determining the film thickness distribution. In this case, for subsequent wafers of the same product, it is possible to implement measurement using a minimum number of measurement points, as illustrated in FIG. 30 and FIG. 31, on the basis of the data obtained for the film thickness distribution analysis for the first wafer.

Moreover, the film thickness data and film thickness distribution data for each measurement point as obtained by the film thickness measuring device 64 is transferred to a control device (not illustrated), which evaluates and controls the processing by referring to this data.

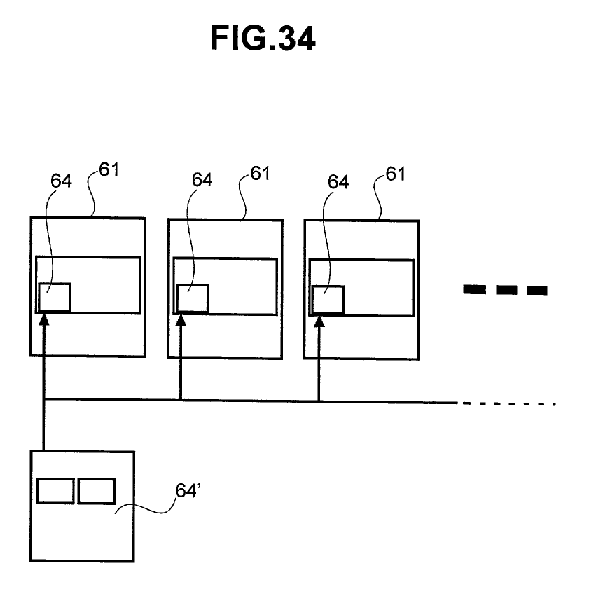

In the example in FIG. 33 described above, the device functions both as a device for determining measurement points for performing film thickness measurement, and as a film thickness measuring device, but these device may be provided separately. FIG. 34 shows one such example.

In FIG. 34, a plurality of CMP processing systems 61 perform processing in parallel, each processing system 61 being provided with a film thickness measuring device 64. 64′ is a stand-alone type film thickness measuring device provided once only for a plurality of CMP processing systems 61, and this stand-alone film thickness measuring device 64′ functions as a device for executing processing for determining measurement points for film thickness measurement, the data for the respective measurement points thus obtained being supplied to the respective film thickness measuring devices 64 of each CMP processing system 61.

Needless to say, the function of the stand-alone film thickness measuring device 64′ may also be combined in the film thickness measuring device 64 of one of the CMP processing systems 61. Moreover, the film thickness measuring devices do not necessarily have to be incorporated into the CMP processing system.

As described above, according to the present invention, it is possible automatically to determine measurement points for measuring the film thickness of transparent film on a circuit pattern buried under an optically transparent thin film, swiftly and accurately, on the basis of general, reliable judgement criteria, without depending on the experience or expertise of the operator. Therefore, it is possible accurately to assess the film thickness distribution in a chip surface or wafer surface, by adopting a measurement point determining method of this kind, thereby contributing to improved yield rate and throughput.

Next, as shown in FIG. 47, in a manufacturing line for semiconductor devices, it is possible to control the processing conditions of the processing equipment which processes the semiconductor substrate, for example, the film forming apparatus, CM apparatus, exposure apparatus, etching apparatus, and the like, by using the measurement results for film thickness obtained by the method for measuring film thickness according to the present invention.

In other words, in a manufacturing process for a semiconductor device comprising: a film forming step for forming a thin film onto a substrate; a CMP step for processing the thin film formed on the substrate; an exposure step for coating resist onto the processed thin film and exposing a pattern thereon; and an etching step for etching the CMP processed thin film using the exposed resist as a mask; film thickness measurement according to the present invention is performed with respect to a substrate which has undergone the film forming step or a substrate which has undergone the CMP step, whereby the thickness of the optical transparent thin film on the substrate is measured to an accuracy of 10 nm or less, and the process conditions of at least one of the film forming step, CMP step, exposure step or etching step, can be controlled according to the results of this measurement.

If, as a result of measuring the film thickness, it is found that the film thickness varies, then this can be considered to have an effect on both the exposure step and the etching step. In the case of the exposure step, the focus is set on any region within the shot, and then exposure is performed, so defects will occur is there is significant variation in film thickness. In this case, if the surface undulations caused by film thickness variation within the shot come within the focal depth of the exposure, at the least, then the focal point can be set to an optimum height by evaluating the variation of the film thickness within the shot, and hence the incidence of defects can be reduced.

In the case of etching also, if there is significant variation in the film thickness, then it may be considered that hole penetration faults, and the like, may occur. In this case also, by evaluating the variation of the film thickness and optimising the etching time, and the like, it is possible to reduce the incidence of defects.

As regards the film-forming step also, if, for example, variation in the film thickness after polishing is altered from variation before polishing, then by evaluating the variation in film thickness after polishing, thickness at film forming may be optimized.

By reflecting the measurement results in the conditions of various processes, as well as the CMP process, of course, it is possible to reduce the incidence of defects.

According to the present invention, it is possible to determine measurement points for controlling film thickness which permit accurate evaluation, automatically and in a short period of time, without requiring great proficiency. Moreover, by applying the aforementioned method, yield and throughput can be improved. For example, it is possible to perform high-precision film thickness control in a CMP step of a method and manufacturing line for manufacturing semiconductor devices onto silicon wafers, as described above, and hence the throughput of the step can be improved.

The invention may be embodied in other specific forms without departing from the spirit or essential characteristics thereof. The present embodiment is therefore to be considered in all respects as illustrative and not restrictive, the scope of the invention being indicated by the a claims rather than by the foregoing description and all changes which come within the meaning and range of eqivalency of the claims are therefore intended to be embraced therein.

What is claimed is:

1. A method for measuring the thickness of thin film, comprising the steps of:
irradiating light onto a sample having a composition in which a pattern formed onto the surface thereof is covered by an optically transparent thin film;
detecting the reflected light generated by said sample due to the irradiation of said light, by means of an optical system; and
determining the thickness of said optically transparent film using spectral waveform information for the reflected light thus detected;
wherein surface area ratio information for said pattern within the detection field of view of said optical system is used in the step of determining the thickness of said optically transparent film.

2. The method for measuring the thickness of thin film according to claim 1, wherein the width of the pattern formed on the surface of said sample is 1 μm or a smaller dimension.

3. A method for measuring the thickness of thin film, comprising the steps of:
irradiating light onto a sample in which a plurality of layers of films are formed and the surface thereof is covered by an optically transparent thin film;
detecting the reflected light generated by said sample due to the irradiation of said light, by means of an optical system; and
determining the thickness of said optically transparent film using spectral waveform information for the reflected light thus detected;
wherein, in the step of determining the thickness of said optically transparent film, regional models having a plurality of layer structures are established, the waveforms of the reflected light from said regional models are calculated, and the thickness of said optically transparent film is determined by fitting, using said calculated waveform information and the spectral waveform information of the detected reflected light.

4. The method for measuring the thickness of thin film according to claim 3, wherein said regional models include regional models in which the reflected light from said pattern is mixed with the reflected light from the layer below said pattern.

5. The method for measuring the thickness of thin film according to claim 3, wherein a plurality of layer structures are established in said regional models, and the regions where these respective structures border each other are established as separate structures.

6. A method for measuring the thickness of thin film, comprising the steps of:
irradiating light onto a sample having a composition in which a pattern formed onto the surface thereof is covered by an optically transparent thin film;
detecting the reflected light generated by said sample due to the irradiation of said light, by means of an optical system; and
determining the thickness of said optically transparent film using spectral distribution waveform information for the reflected light thus detected;
wherein, in the step of determining the thickness of said optically transparent film, a regional model is established which takes into account a region were the reflected light from said pattern and the reflected light from the layer beneath said pattern are mixed, the waveform of the reflected light from the regional model thus established is calculated, and the thickness of the optically transparent film covering said pattern is determined using the waveform information thus calculated and the spectral waveform information of said detected reflected light.

7. The method for measuring the thickness of thin film according to claim 6, wherein the width of the pattern formed onto the surface of said sample is 1 μm or a smaller dimension.

8. A method for measuring the thickness of thin film, comprising the steps of:
irradiating light onto a wafer surface;
detecting the reflected light from said wafer surface generated by said irradiation of light; and
measuring the film thickness on the basis of the reflected light thus detected;
wherein, in the step of measuring said film thickness, measurement points are determined using spectral data from said detected reflected light;

9. The method for measuring the thickness of thin film according to claim 8, wherein said measurement points are determined using information relating to the position and size indicating the maximum value or minimum value of the spectral data of said reflected light.

10. The method for measuring the thickness of thin film according to claim 8, wherein frequency analysis of the spectral data of said reflected light is performed and said measurement points are determined on the basis of the results of said frequency analysis.

11. The method for measuring the thickness of thin film according to claim 8, wherein the surface area ratio of the structure to be measured within the measurement field of view is determined from the spectral data of said reflected light, and said measurement points are determined using the surface area ratio information thus determined.

12. An apparatus for measuring the thickness of thin film, comprising:
irradiating means for irradiating light onto a sample having an optically transparent thin film formed onto the surface thereof;
detecting means for detecting the reflected light generated by said sample due to the irradiation of said light by said irradiating means, by means of an optical system; and
film thickness calculating means for calculating the film thickness from the data detected by said detecting means;
wherein said film thickness calculating means determines the thickness of said optically transparent film by using surface area ratio information for said pattern within the detection field of view of said optical system.

13. The apparatus for measuring the thickness of thin film according to claim 12, wherein said detecting means detects light in the wavelength band of 400-800 nm.

14. The apparatus for measuring the thickness of thin film according to claim 12, further comprising measurement point determining means for determining measurement points using spectral data for the reflected light detected by said detecting means.

15. The apparatus for measuring film thickness according to claim 14, wherein said measurement point determining means determines measurement points using information relating to the position and size indicating the maximum value or minimum value of the spectral data of said reflected light.

16. The apparatus for measuring film thickness according to claim 14, wherein said measurement point determining means performs frequency analysis of the spectral waveform data of said reflected light and determines measurement points having desired conditions on the basis of the results of said frequency analysis.

17. The apparatus for measuring film thickness according to claim 14, wherein said measurement point determining means determines the surface area ratio in the measurement field of view of the structure being measured from the spectral data of said reflected light and determines measurement points using the surface area ratio information thus determined.

18. An apparatus for measuring the thickness of thin film, comprising:
irradiating means for irradiating light onto a sample having an optically transparent thin film formed onto the surface thereof;
detecting means for detecting the reflected light generated by said sample due to the irradiation of said light by said irradiating means, by means of an optical system; and
film thickness calculating means for calculating the film thickness from the data detected by said detecting means;
wherein said film thickness calculating means establishes a regional model comprising a plurality of layer structures calculates the waveform of the reflected light from said regional model, and determines the thickness of said optically transparent film by fitting, using the waveform information thus calculated and the spectral waveform information of the detected reflected light.

19. The apparatus for measuring the thickness of thin film according to claim 18, wherein said detecting means detects light in wavelength band of 400-800 nm.

20. The apparatus for measuring the thickness of thin film according to claim 18, further comprising measurement point determining means for determining measurement points using spectral data for the reflected light detected by said detecting means.

21. The apparatus for measuring film thickness according to claim 20, wherein said measurement point determining means determines measurement points using information relating to the position and size indicating the maximum value or minimum value of the spectral data of said reflected light.

22. The apparatus for measuring film thickness according to claim 20, wherein said measurement point determining means performs frequency analysis of the spectral waveform data of said reflected light and determines measurement points having desired conditions on the basis of the results of said frequency analysis.

23. The apparatus for measuring film thickness according to claim 20, wherein said measurement point determining means determines the surface area ratio in the measurement field of view of the structure being measured from the spectral data of said reflected light and determines measurement points using the surface area ratio information thus determined.

24. A method for measuring film thickness comprising the steps of:
irradiating light onto a particular chip of a plurality of chips on a wafer formed with a plurality of chips whereon a circuit pattern and an optically transparent thin film for covering said circuit pattern are formed respectively;
detecting the light reflected by the particular chip region of said wafer due to said irradiated light;
determining measurement points for measuring the film thickness of said optically transparent thin film on said wafer by using information for the spectral waveform data of the reflected light thus detected; and
measuring the film thickness of said optically transparent thin film at said measurement points, by successively irradiating light onto the measurement points thus determined.

25. The method for measuring film thickness according to claim 24, wherein, in said step of determining said measurement points, measurement points are determined by using information obtained by frequency analysis of the spectral waveform data of the reflected light thus detected.

26. The method for measuring film thickness according to claim 25, wherein the measurement points are determined by using information for the high-frequency component intensity and the low-frequency component intensity obtained by frequency analysis of the spectral waveform data of the reflected light thus detected.

27. The method for measuring film thickness according to claim 24, wherein, in said step of determining said measurement points, the measurement points are determined by using information for the waveform periodicity of the spectral waveform data of the reflected light thus detected.

28. The method for measuring film thickness according to claim 24, wherein, in said step of determining said measurement points, the measurement points are determined by using information obtained by fitting the spectral waveform data of the reflected light thus detected with logical waveform data.

29. A method for fabricating semiconductor devices, comprising:
a film forming step for forming thin film on a substrate;
a CMP step for processing the thin film formed on said substrate;
an exposure step for coating resist onto said thin film thus processed and exposing a pattern thereon to light;
an etching step for etching said CMP processed thin film, using said exposed resist as a mask; and
a step for irradiating light onto the substrate having undergone said film forming step or the substrate having undergone said CMP step, detecting the reflected light from said substrate generated by said irradiation, obtaining spectral data for said reflected light, and measuring the thickness of the thin film on the substrate using the spectral data, to an accuracy of 10 nm or less;
wherein the process conditions of at least one process of said film forming step, CMP step, exposure step and etching step is controlled using the results measured in said measuring step.

30. The method of manufacturing a semiconductor device according to claim 29, wherein, in the step of measuring the thickness of said thin film, regional models comprising a plurality of layer structures are established, the waveform of the reflected light from said regional models is calculated, and the thickness of said optically transparent film is determined by fitting, using the waveform information thus determined and the spectral waveform information of the detected reflected light.

31. The method of manufacturing semiconductor devices according to claim 30, wherein said regional models include regional models in which reflected light from said pattern and reflected light from the layer beneath said pattern are mixed.

32. The method of manufacturing semiconductor devices according to claim 29, wherein the regions where the respective structures border each other are established as separate structures in the regional models comprising said plurality of layer structures.

33. A method for manufacturing semiconductor devices, comprising:
a film forming step for forming thin film on a substrate;
a CMP step for processing the thin film formed on said substrate;
an exposure step for coating resist onto said thin film thus processed and exposing a pattern thereon to light;
an etching step for etching said CMP processed thin film, using said exposed resist as a mask;
a step for irradiating light onto the substrate having undergone said film forming step or the substrate having undergone said CMP step, detecting the reflected light from said substrate generated by said irradiation, obtaining spectral data for said reflected light, determining measurement points using this spectral data, and measuring the thickness of the thin film at each of the measurement points thus determined; and
a step for measuring the thickness of the thin film on the substrate having undergone said film forming step or the substrate having undergone said CMP step, at each measurement point determined using the spectral data of said reflected light as obtained by detecting the reflected light of the light irradiated onto said substrate;
wherein the process conditions of at least one process of said film forming step, CMP step, exposure step or etching step is controlled using the results measured in said measuring step.

34. The method for manufacturing semiconductor devices according to claim 33, wherein, in the step of measuring the thickness of said thin film, regional models comprising a plurality of layer structures are established, the waveform of the reflected light from said regional models is calculated, and the thickness of said optically transparent film is determined by fitting, using said calculated waveform information and the spectral waveform information of said detected reflected light.

35. The method of manufacturing semiconductor devices according to claim 33, wherein said regional models include regional models in which reflected light from said pattern and reflected light from the layer beneath said pattern are mixed.

36. The method of manufacturing semiconductor devices according to claim 33, wherein the regions where the respective structures border each other are established as separate structures in the regional models comprising said plurality of layer structures.
